(19) United States
(12) Patent Application Publication
(10) Pub. No.: US 2013/0112148 A1
(43) Pub. Date: May 9, 2013

(54) Horse Feeder

(71) Applicant: Monique Warren, Ramona, CA (US)

(72) Inventor: Monique Warren, Ramona, CA (US)

(21) Appl. No.: 13/290,990

(22) Filed: Nov. 7, 2011

(51) Int. Cl. A01K 5/01

(52) U.S. Cl. 119/65

(57) ABSTRACT

The present invention relates to an animal feeder for the controlled consumption of hay or similar feed to a horse, other equidae or similar grazing animal. The invention provides such feeders in the form of flexible receptacles having an area of open mesh through which the animal consumes the contents of the receptacle over predetermined period of time dependant upon the size of the mesh openings chosen. Such feeders are configured such that a feeding animal in a standing position can only access feed disposed within the receptacle when the feeding animal's head is lowered in a natural feeding headset.

### FIELD OF THE INVENTION

The present invention relates to a feeder for the controlled consumption of hay or similar feed to a horse, other equidae or similar grazing animal.

### BACKGROUND

In nature, equidae such as horses chew their food slowly and thoroughly, therefore never over-consuming, while many domesticated equidae such as horses or similar grazing animal are allowed to graze at pasture others are fed in a stall or other location. Additionally many pastured horses must also be stall fed at certain times of year when the pasture may be barren of food or when the weather conditions do not permit pasture feeding. The common food choice for stall fed horses is hay, sometimes mixed with food additives such as vitamins and the like. A normal horse consumes on the order of between 2-3 percent of it's own weight in the dry weight equivalent of feed daily.

A major problem associated with stall-feeding is that the animal eats too fast. The horse's receptors for feeling full are located in its chewing muscles—not its stomach. This is why it is essential that the horse chews feed slowly and vigorously. If the horse eats too fast, as is encouraged with traditional feeding methods, the animal will not feel content and full and therefore will overeat and feel stressed. Side effects of this state will cause the horse will be nervous, edgy and disobedient. A horse's stomach is relatively small for its size and food passes through in as little as 12 min. From the stomach the food passes on to the small intestine, where it stays for only about 90 min. This means that 90 minutes after the stomach is empty the small intestine is also empty. This creates a problem for the horse because of the continuous production of digestive fluids (acids), which ultimately burn the inside of the digestive tract when there is no food there to absorb such fluids. This is a situation that would always occur if when horse is fed 2-4 times per day as in traditional stall-feeding.

Fast eating by a horse can also results in result in potentially harmful side effect such as “choke” or esophageal obstruction. “Bolus eating” is an expression often used to describe feeding habits of horses that are permitted to eat hay free choice and en-masse, wherein the feed is consumed without being properly chewed, as is vital for proper digestion. Because equidae such as horses sleep only 3 to 4 hours in a 24 hour period and usually no longer than 20 minutes at a time, food tends to be their main focus. A common practice by horse owners across the globe is to feed the animal 2 to 4 times per day and generally in quantities that can be consumed by the horse in one to two hours often causing one or more of the harmful effects explained above. An equally harmful practice is the commonly found bale-feeding method wherein large bales of feed are dumped into bulk feeding devices more suited for cattle or are just dropped on the ground. Such methods allow the horse to eat in a bolus manner with no controls to restrict the speed or quantity of feed consumption.

Slowing down the rate at which such animals can access feed such as hay means that the crucial process of digestion is slowed down such that vital nutrients in the feed are absorbed much more efficiently. A slow continuous feeding system simulates constant foraging, thereby stimulating the animal's digestive as nature has intended.

Many equidae feeding devices are known in the art. For example U.S. Pat. No. 993,286 to Avery describes and claims a feedbag for a horse that prevents the animal from holding the bag straight such that feed runs out of the bag, while U.S. Pat. No. 1,368,911 to Engler describes and claims a feedbag wherein the contents are prevented from scattering in the event that the horse throws it's head back in an attempt to obtain food in the bottom of the bag. Such designs supply only a limited quantity of food per filling and do not slow down the rate at which such animals can access feed within the bag. Another device is the feed bucket described in U.S. Pat. No. 5,105,769 to Smith, this design prevents the horse from pushing the feed out of the bucket, it does not however prevent the horse from bolting his feed, taking large bites of grain and removing his head from the feeder thereby dropping the feed onto the ground.

Another feeder described in U.S. Pat. No. 5,394,832 to Briley allows a horse to enter its head into an enclosed chamber to access feed. This design does not limit the amount of food accessible to the animal over time so it does not present a slow continuous feeding system that simulates the animal's natural grazing.

None of the horse feeders described above dispenses small manageable bites of feed in a manner easily digestible by the horse.

Certain mechanical devices have been proposed to control the speed with which the horse consumes hay in order to prevent both choke and overeating. Such devices, which work with varying degrees of effectiveness, tend to be complex in design and construction, making such devices expensive to manufacture, obtain and maintain (examples). Furthermore, some known feeding devices (such as), especially those that rely on springs for their proper functioning, have the potential to cause injury to the animal during use.

In U.S. Pat. No. 4,294,197 to Snel et al. a mechanical box for feeding horses is described, wherein the top of the box is provided with a series of spaced bars through which a horse can feed or hay disposed in the upper portion of the box and a movable plate within the box wherein springs exert pressure on the movable plate to push hay upward while the animal feeds. This design fails to address the problem of horse feeding too quickly since the design does not slow down the rate at which such animals can access feed within the box.

The U.S. Pat. No. 5,555,842 to Chocola et al. describes and claims an electro mechanical device for automatically providing a preset, metered amount of horse feed to a stall, however such a complex device is both expensive and difficult to maintain, while U.S. Pat. No. 6,637,368 to Bondarenko et al. describes and claims a mechanical feed dispenser for livestock involving a plurality of control levers, indexed holes and metering gates that is complex in design.

Accordingly, there exists a need in the art for a device that helps control the speed with which a horse consumes hay in a stall or other non-pasture setting in order to help prevent ulcers, stress or choking as well as overeating with their attendant problems. Such a device must be simple in design and construction and be easy to use and maintain. Such a device must have minimal potential for causing injury to the horse and owner alike. Embodiments of the present invention fill these needs as well as other needs.

It is an object of this invention to provide a feeder that dispenses small manageable bites of feed regulated by the horse.

It is therefore an object of this invention to provide a feeder that reduces both economic and nutritional loss associated with previous horse feeder designs.

It is also an object of this invention to provide a feeder that is simple in design and construction, is easy to use and maintain and presents minimal potential for causing injury to the horse and owner alike.

It is an additional object of this invention to provide a feeder that can be used both indoors or outdoors.

Other objects and advantages will be more fully apparent from the following disclosure and appended claims.

### BRIEF DESCRIPTION OF THE DRAWINGS

FIG. 1 depicts a top orthogonal view of an embodiment of a horse feeder of the present invention.

FIG. 2 depicts a bottom orthogonal view of an embodiment of a horse feeder of the present invention.

FIG. 3 depicts a side orthogonal view of an embodiment of a horse feeder of the present invention.

FIG. 4 depicts a perspective view of an embodiment of a horse feeder of the present invention in use by a feeding horse.

FIG. 5 depicts a detailed view of a portion of FIG. 4.

FIG. 6 depicts a top orthogonal view of an embodiment of a horse feeder of the present invention having a grommet and cord closure, wherein the feed entry opening is in an open position.

FIG. 7 depicts a side orthogonal view of an embodiment of a horse feeder of the present invention having a grommet and cord closure, wherein the feed entry opening is in an open position.

FIG. 8 depicts a top orthogonal view of an embodiment of a horse feeder of the present invention having a grommet and cord closure, wherein the feed entry opening is in a closed position.

FIG. 9 is a perspective view of an embodiment of the hanging horse feeder of FIGS. 6-8, wherein the device is hanging in a stall and is in use by a feeding horse.

FIG. 10 depicts an isometric view of an embodiment of a hanging animal feeder of the present invention.

FIG. 11 depicts a side orthogonal view of an embodiment of the hanging animal feeder FIG. 10.

FIG. 12 depicts an isometric view of an embodiment of an animal feeder of the present invention configured to contain a bale of hay, wherein the feeder is in an open position.

FIG. 13 depicts a frontal orthogonal view of the animal feeder depicted in FIG. 12 wherein the feeder is in a closed position.

FIG. 14 depicts an exploded isometric view of an embodiment of an animal feeder of the present invention configured to contain a bale of hay.

FIG. 15 depicts an isometric view of an embodiment of an animal feeder of the present invention configured to contain a bale of hay.

FIG. 16 depicts a sectional view of the feeding device containing a bale of hay depicted in FIG. 15.

FIG. 17 depicts a sectional view of the feeding device depicted in FIG. 16, wherein a portion of the hay has been consumed.

FIG. 18 depicts a sectional view of the feeding device depicted in FIG. 17, wherein a further portion of the hay has been consumed.

FIG. 19 depicts a sectional view of the feeding device depicted in FIG. 18, wherein a still further portion of the hay has been consumed.

### SUMMARY OF THE INVENTION

Embodiments of the present invention provide feeders for the controlled consumption of hay or similar feed to a horse, other equidae or similar grazing animal. The devices regulate both the amount and the rate of feed that the animal can consume. Such a device provides a feeding method that is modeled on the manner in which horses naturally forage and therefore promotes eating habits that benefit the health of the animal.

Certain embodiments of the present invention provides a flexible bag-like receptacle, having a top wall a bottom wall and four edges wherein at least one edge defines an opening through which a desired quantity of dry animal feed can be introduced and wherein the opening has a reversible sealing mechanism that can be conveniently closed after the feed has been introduced. In certain embodiments the reversible sealing mechanism is a zipper, while in other embodiments the preferred reversible sealing mechanism comprises a plurality of grommets and a rope, chord or strap. At least a portion of the top wall is an open mesh material wherein the size of the mesh is chosen to permit only limited amounts of animal feed disposed within the receptacle to be accessed through the mesh by a feeding animal. The mesh size is therefore chosen so that the feeding animal consumes the contents of the receptacle over predetermined period of time.

Although there is no limitation as to the type of dry feed used in the feeder, preferred embodiments of the feeder are designed for the use of hay or mixtures containing hay.

In certain embodiments the flexible bag-like receptacle is configured so that bottom wall rests upon a ground surface such that the top wall is facing in an upward direction. By this arrangement a feeding animal can only access animal feed through the mesh of the receptacle if the feeding animal is in a standing position with its head lowered, which is the natural feeding headset for an equidae. This arrangement simulates the natural grazing of the animal.

In certain embodiments a flexible receptacle is dimensioned and configured to accommodate a standard size square or rectangular bale of hay. In such an embodiment a bound bale of hay is introduced into the feeder receptacle after which the baling wire or twine is removed and the receptacle is closed and secured by means of a reversible closure such as a zipper. In certain variations of this embodiment the body of the feeder receptacle is provided with pleats so that the receptacle collapses under its own weight as the bale of hay contained therein is consumed by a feeding horse, such that as the feeder receptacle collapses, the hay within is moved toward the feeding mesh to be accessible to the feeding animal.

In certain embodiments of the invention a flexible bag-like receptacle is provided with an hanging means such as a strap or rope for conveniently hanging it on an element of a barn or stall such that the a feeding animal can access the feed through the mesh if the feeding animal is in a standing position with its head lowered. In certain of such embodiments the opening through which animal feed has been introduced is reversibly sealed by tightly drawing and knotting a rope threaded through a series of grommets disposed about the periphery of the opening and the same rope is utilized as the hanging means.

In certain embodiments, wherein the flexible bag-like receptacle is configured so it can be hung on a wall, fence, post or similar structure of a stall, the lower edge of the receptacle is constructed of a bottom mesh material with a mesh size that allows fine debris such as dirt and dust to pass through while retaining the feed within the receptacle. By this arrangement a feeding animal can only access animal feed through the mesh of the receptacle if the feeding animal is in a standing position with its head lowered in the natural feeding headset for an equidae.

In preferred embodiments the components of the feeder are constructed of abrasion resistant and cut resistant materials. Such cut resistant and abrasion resistant materials are resistant to cutting by the teeth of the feeding animal as well as abrasion resulting from the device scrapping against the ground.

### DETAILED DESCRIPTION OF THE INVENTION

As used herein, the following terms shall have the following meaning:

“mesh” is herein defined as an openwork structure having open spaces in a network and cords, threads, or wires surrounding these spaces.

“cord” is herein defined as rope, string, wire, cord and the like including bungee cord and elastic cable or cord.

“grommets” are herein defined as perforations reinforced with grommets.

In certain embodiments of animal feeders the present invention the feeder is a flexible receptacle having a top wall, a bottom wall, and a feed entry opening wherein at least a portion of the top wall comprises a flexible feeding mesh with feeding mesh openings of a size chosen to permit only limited amounts of animal feed disposed within the receptacle to be accessed through the open mesh by a feeding animal, such that the feeding animal consumes the contents of the receptacle over a period of time dependant upon the size of the feeding mesh openings chosen. Such a feeder is configured such that when bottom wall rests upon a ground surface, the top wall is facing in a upward direction such that a feeding animal in a standing position can only access feed disposed within the receptacle when the feeding animal's head is lowered in a natural feeding headset.

In certain other embodiments the feeder is in the form of a flexible rectangular cuboid having a top wall, a bottom wall and four sidewalls wherein at least a portion of the top wall comprises a flexible feeding mesh. Such embodiments may be sized to accommodate a bale of hay or similar feed and wherein a feed entry opening is disposed circumferentially about at least three of the four sidewalls of the receptacle. In variations these embodiments the four sidewalls each comprise one or more pleats parallel to the bottom wall and wherein each pleat is disposed to be contiguous with the pleats of adjacent sidewalls such that the four sidewalls are fully extended when the feeder is filled with animal feed and collapse in an accordion-like manner as feed within the feeder is consumed by a feeding animal.

In certain other embodiments the feeder has the form of a flexible bag-like receptacle, having a front wall, a back wall, a closed bottom and an open top; wherein the open top is configured to function as a feed entry opening and wherein at least a portion of front wall comprises a flexible feeding mesh. Certain variations of these embodiments provide a hanging means such as a cord, belt, strap or the like disposed such that the receptacle can be hung in a stall or other such animal housing so that the flexible open mesh is positioned wherein a feeding animal in a standing position can access feed disposed within the receptacle only when the feeding animal's head is lowered in a natural feeding headset. In variations of such embodiments the feed entry opening is provided with a reversible sealing means such as zippers, snaps, ties, buckles, hook and loop fastener such as Velcro™ and the like. In certain preferred embodiments the reversible sealing means comprises a plurality of grommets disposed around the periphery of the feed entry opening and a cord threaded through the grommets such that the feed entry opening is sealed when the chord is pulled taught. In such embodiments the chord may also function as a hanging means.

In certain embodiments of the hanging type feeders of the present invention closed bottom comprises a bottom mesh that is sized to allow fine debris to pass through while retaining feed disposed within the receptacle.

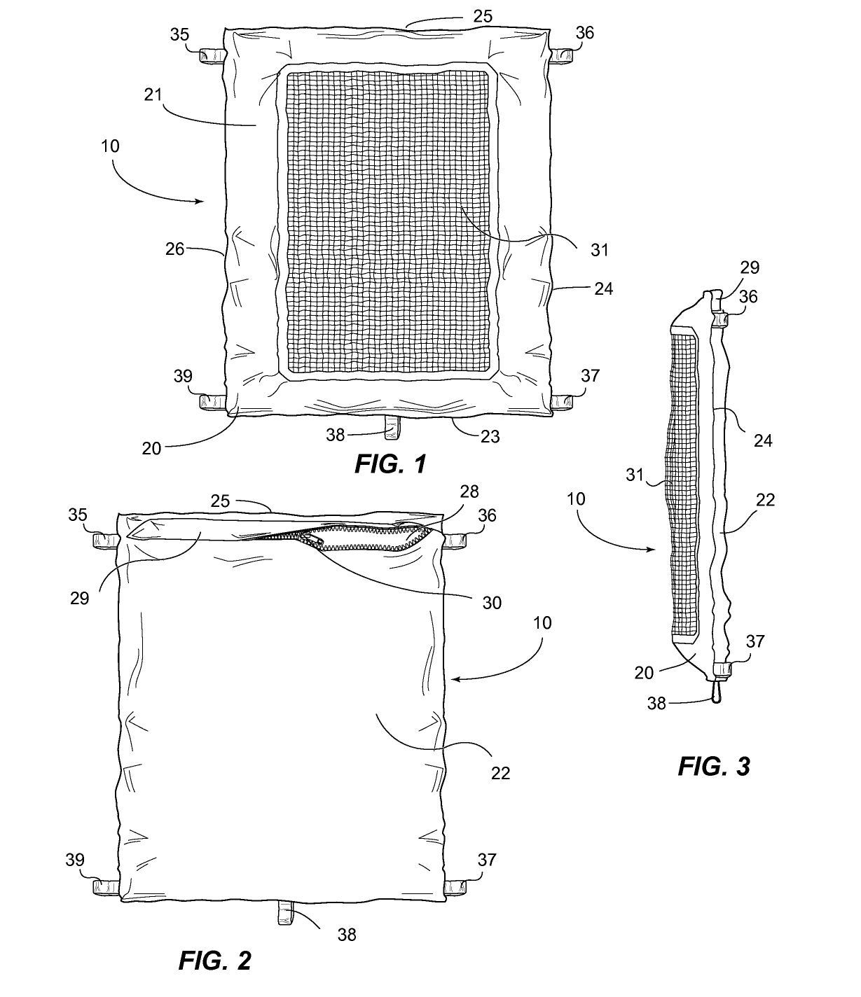

FIGS. 1, 2 and 3 depict an orthogonal top view, bottom view and side view respectively of an embodiment of a horse-feeding device 10. The device 10 consists of a flexible bag-like receptacle 20, having a top wall 21, a bottom wall 22 and four side edges 23, 24, 25 and 26. As shown in FIG. 1, a portion of the top wall 21 is configured to have an area comprising a flexible open feeding mesh 31. The size of the feeding mesh openings is chosen to permit only limited amounts of animal feed disposed within the receptacle to be accessed through the open feeding mesh 31 by a feeding animal such that the feeding animal consumes the contents of the receptacle over a period of time is dependant upon the size of the feeding mesh openings.

The orthogonal bottom view of the feeding device 10 depicted in FIG. 2 clearly shows the bottom wall 22 of the bag-like receptacle 20, wherein an area of the bottom wall 22 is configured to define a feed entry opening 28 in bottom wall 22 disposed near and parallel to the edge 25; and extending across nearly the entire width of the bottom wall 22. In the embodiment of feeding device 10, the feed entry opening 28 is reversibly sealable via a zipper mechanism 30, illustrated in FIG. 2 in a partially closed configuration, wherein the zipper 30, when in a closed configuration, is totally covered by an optional zipper cover flap 29. The feed entry opening 28 is dimensioned such that a desired quantity of dry horse feed such as hay can be introduced there through.

In other such embodiments the feed entry opening is disposed on an edge or top wall of the feeder and the reversible sealing mechanisms are chosen from the group including, but not limited to, zippers, snaps, ties, buckles, hook and loop fastener such as Velcro™ and the like.

The feeding device 10 depicted in FIGS. 1, 2 and 3 is further provided with optional flexible loops 35, 36, 37, 38 and 39 by which the feeding device 10 can be conveniently be grasped to be dragged or secured with straps, ropes or the like.

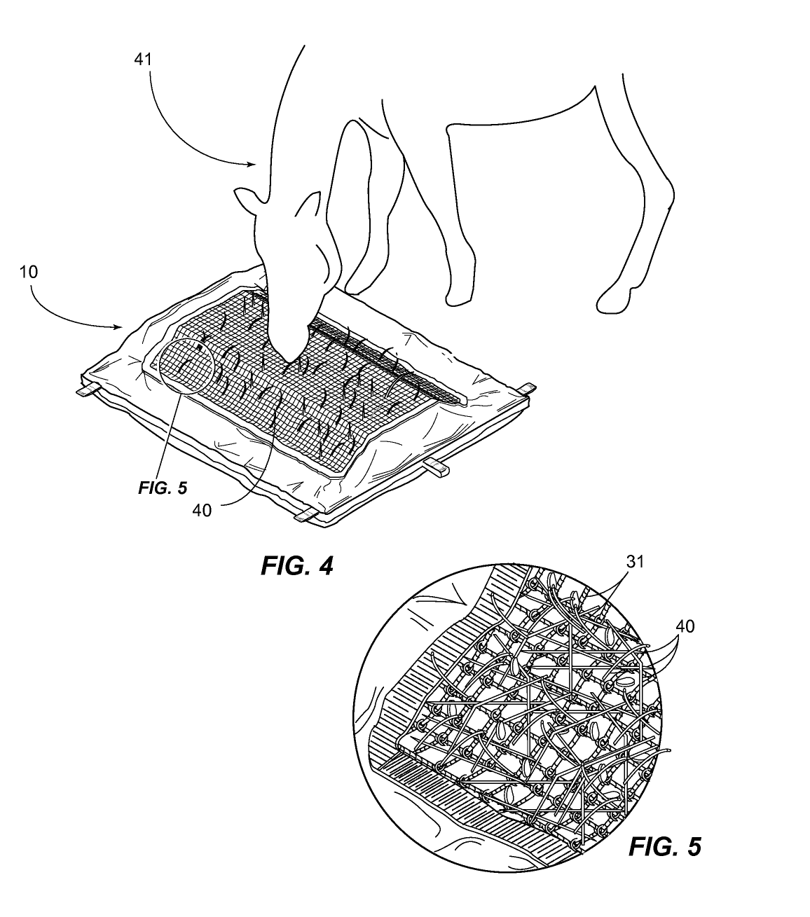

In FIG. 4 a perspective view of the feeding device 10 is illustrated to contain a quantity of hay 40 being consumed by a feeding horse 41. FIG. 5 is shows a detail view of a portion of device 10 clearly showing the relationship of the open mesh 31 and the hay 31 disposed within. FIG. 5 particularly illustrates the limited accessibility to the feeding horse 41 of hay 40 protruding through openings of the mesh 31.

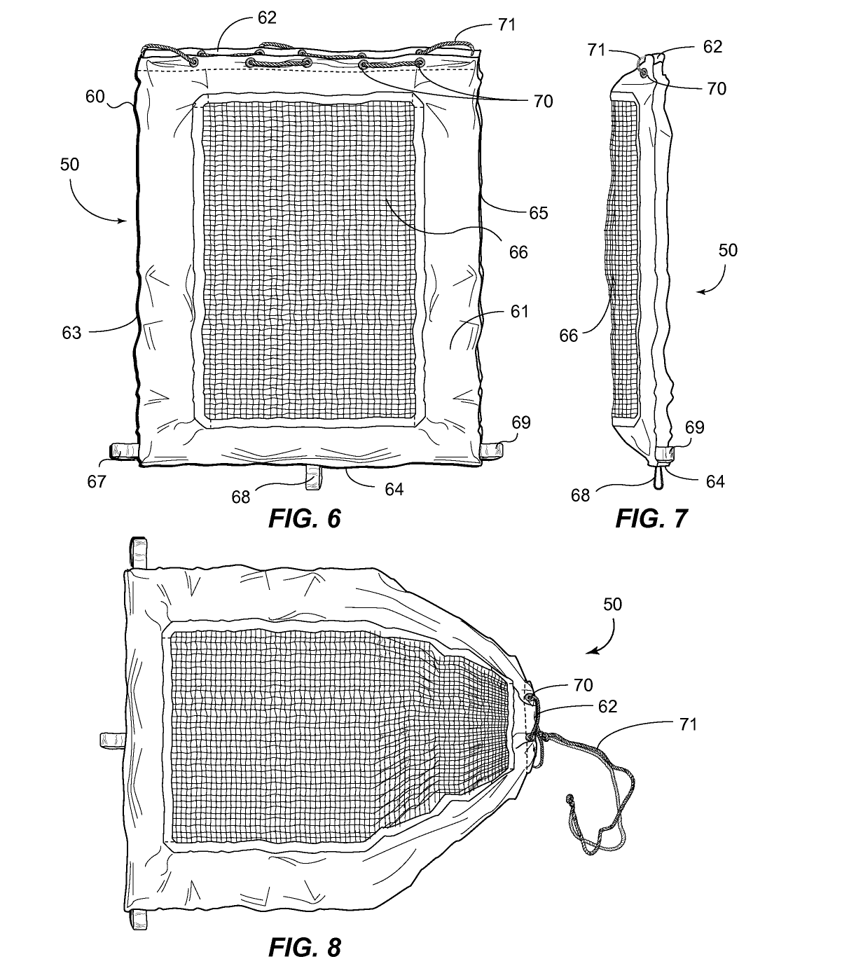

In certain embodiments of the invention a flexible bag-like receptacle is provided with an element such as a strap for conveniently hanging it on a wall of a barn or stall such that the a feeding animal can access the feed through the mesh if the feeding animal is in a standing position with its head lowered. In certain embodiments, wherein the flexible bag-like receptacle is configured such that it can be hung on the wall of a stall, the lower edge of the receptacle is constructed of a bottom mesh material that is sized to allow fine debris such as dirt and dust to pass through while retaining the feed within the receptacle. FIGS. 6 and 7 depict orthogonal top view and side views respectively of an embodiment of such a feeding device 50 consisting of a flexible bag-like receptacle 60, having a top wall 61 and an open edge opening 62 and three closed edges 63, 64 and 65. This feeding device 50 is also provided with optional loops 67 and 69 by which the feed can be conveniently be dragged or secured with straps, ropes or the like. A portion of the top wall 61 comprises an open mesh 66. In such an embodiment a plurality of grommets 71 (two of ten grommets are indicated in FIG. 6) are disposed about the periphery of the open edge 62 and a closure rope 72 is disposed with the grommets 71 such that the open edge opening 62 can be closed or partially closed by drawing and knotting of the closure rope 72 in order to retain animal feed disposed with the feeding device 50. In FIGS. 6 and 7 the open edge 62 is depicted in a fully opened configuration. FIG. 8 depicts an orthogonal top view of the embodiment of a feeding device 50 as depicted in FIGS. 6 and 7, but wherein the closure rope 72 has been drawn and knotted such that the open edge 62 is secured in a closed position. The feeding device 50 further comprises an optional bottom open mesh 70 disposed along the lower portion of the top wall 60 adjacent the edge 62, such that when the feeding device 50 is disposed in a hanging position the bottom open mesh 70 allows fine debris such as dirt and dust to pass through while retaining the feed disposed within the receptacle.

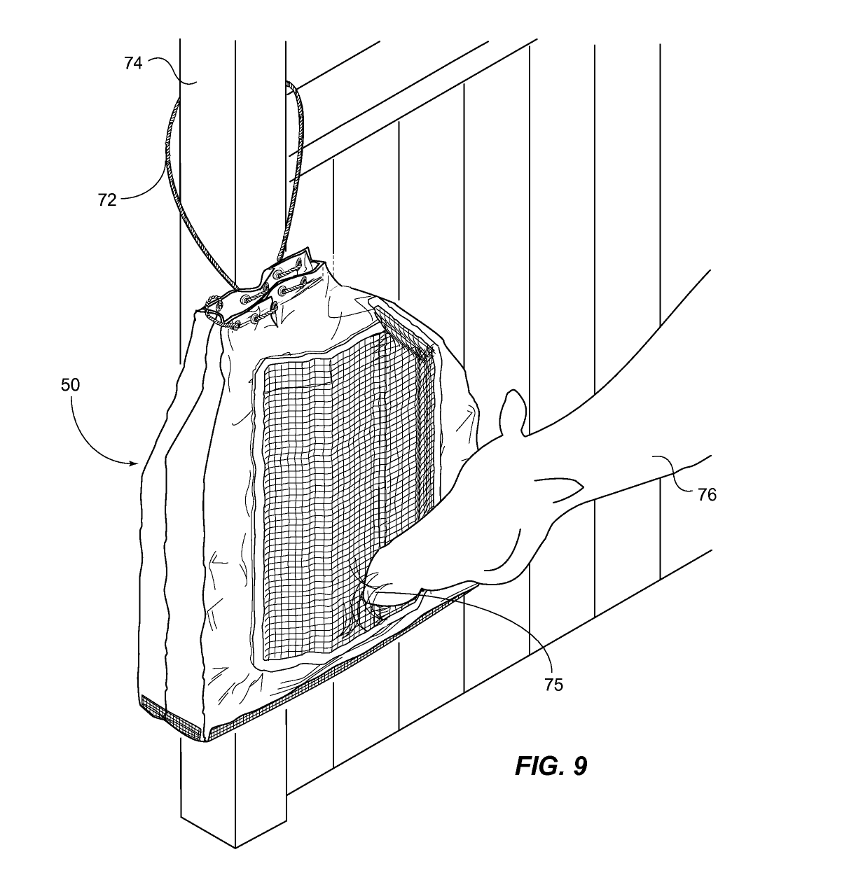

FIG. 9 illustrates the feeding device 50 of FIGS. 6-8 in use by a feeding horse. The device 50 is tethered via rope 72 to a stall post 75, contains animal feed 75 and is in use by a feeding horse 76.

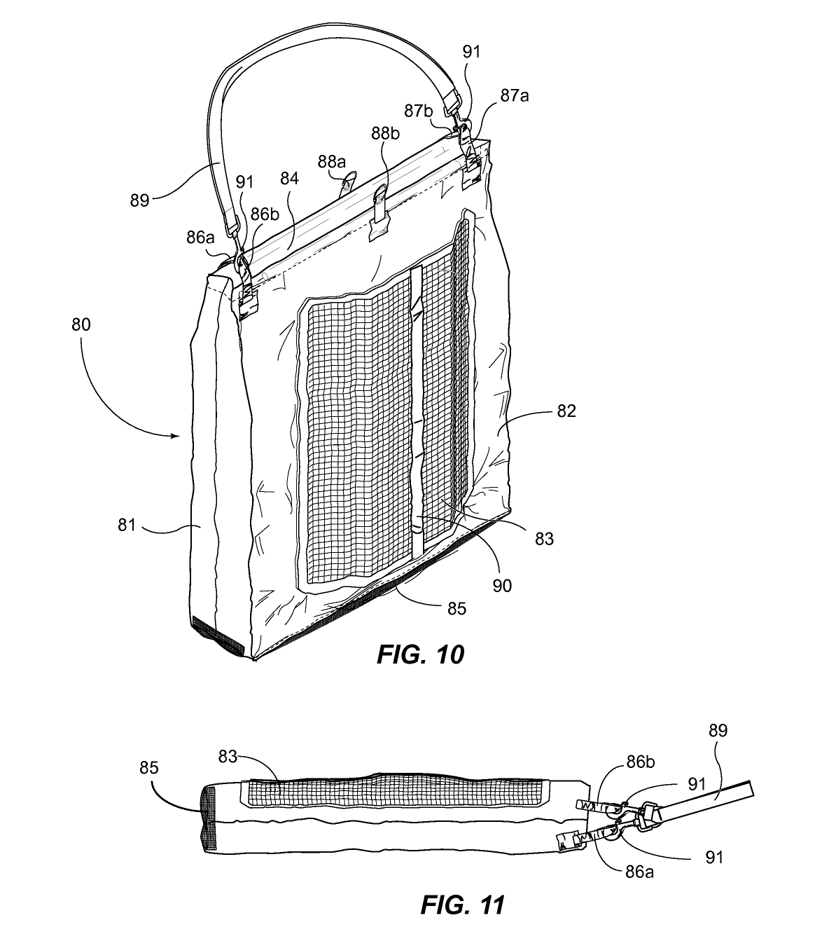

In FIG. 10 an isometric view of a hanging feeding device 80 of the present invention is depicted. The hanging feeding device 80 comprises an abrasion resistant flexible bag-like receptacle 81 having a receptacle front wall 82 a portion of which comprises a front open mesh 83; an open top 84 through which feed can be introduced; and a bottom open mesh 85. The front wall 82 further comprises an optional non-mesh reinforcing strip 90 which can be fabricated from the same abrasion resistant flexible material as the bag-like receptacle 81 or may be fabricated from a different abrasion resistant material. The size of the mesh openings of the front open mesh 83 is chosen to permit only limited amounts of animal feed disposed within the receptacle to be accessed through the open mesh 31 by a feeding animal such that the feeding animal consumes the contents of the receptacle over a period of time is dependant upon the size of the mesh openings. The size of mesh openings of bottom open mesh 85 is chosen to allow fine debris such as dirt and dust to pass through while retaining the feed disposed within the receptacle. The hanging feeding device 80 also comprises flexible loops 86a, 86b, 87a, 87b, 88a, and 88b fixedly attached to the receptacle 81 around the periphery of the receptacle open top 94. The flexible loops 86a, 86b, 87a, 87b, 88a, and 88b re disposed and configured such that the feeding device 80 can be hung from a wall, post, beam or the like by means of a strap 89 provided with closable hooks 91 which are sized to engage flexible loop pairs 86a/86b and 87a/87b respectively. The orthogonal side view of feeding device 80 illustrated in FIG. 11 clearly shows the strap 89 engaged within the pairs of flexible loop 86a/86b and 87a/87b by closable hooks 91.

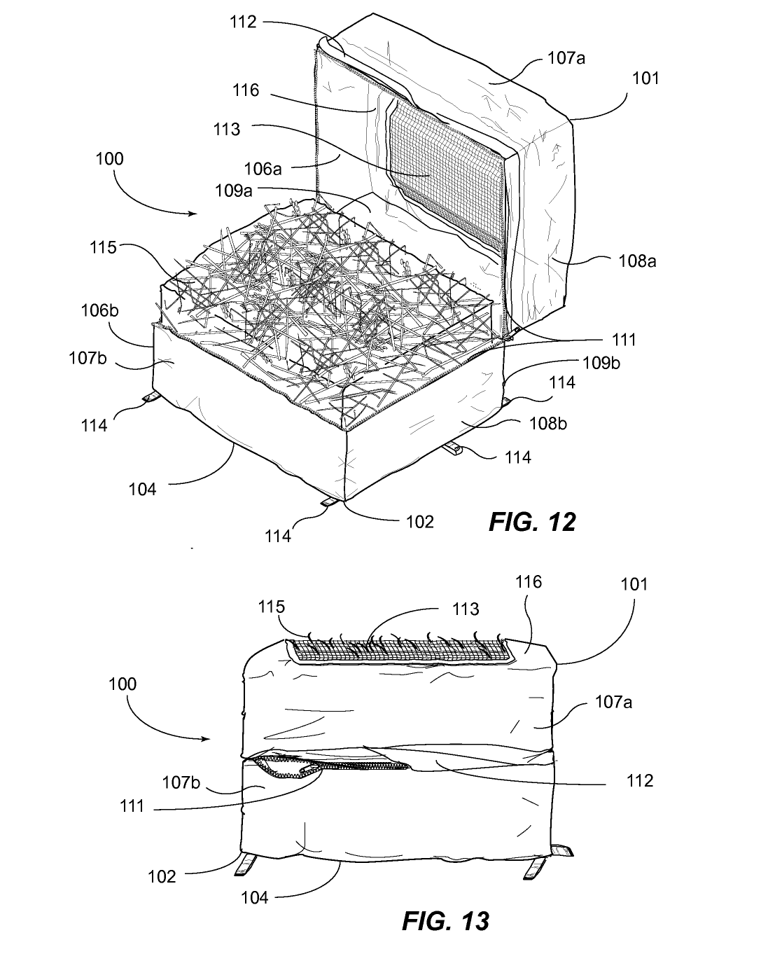

In certain embodiments of the present invention a flexible receptacle is dimensioned and configured to accommodate a standard size square or rectangular bale of hay. In such an embodiment a bound bale of hay is introduced into the feeder receptacle after which the binding wire or twine is removed and the receptacle is closed and secured by means of a reversible closure such as a zipper. Such an embodiment is exemplified by the horse-feeding device 100 illustrated in FIGS. 12 and 13, wherein a flexible feeder receptacle has the form of a rectangular cuboid comprising an upper feeder receptacle portion 101 and a lower feeder receptacle portion 102. The upper feeder receptacle portion 101 has a top wall 116, and four upper sidewalls 106a, 107a, 108a and 109a. A portion of the top wall 116 comprises a flexible open mesh 113, wherein the size of the mesh openings is chosen to permit only limited amounts of animal feed disposed within the receptacle to be accessed through the open mesh by a feeding animal such that the feeding animal consumes the contents of the receptacle over a period of time is dependant upon the size of the mesh openings. The lower feeder receptacle portion 102 has a bottom wall 104, and four lower sidewalls 106b, 107b, 108b and 109b. The upper sidewalls 106a, 107a, 108a are joined to the lower sidewalls 106b, 107b, 108b respectively by a reversible closure in the form of a zipper 111. The upper sidewalls 109a and 109b have a unitary construction such that when the zipper 111 is opened the upper feeder receptacle portion 101 can be separated from the lower portion 102, while the unitary upper sidewalls 109a and 109b act a hinge. Such a configuration allows that a bale of hay 115 can be easily disposed within the horse-feeding device 100 as illustrated in FIG. 12. FIG. 13 illustrates the horse-feeding device 100 of FIG. 12, wherein the zipper 111 is essentially closed. Also the horse-feeding device 100 illustrated in FIGS. 12 and 13 further is depicted with an optional zipper flap 112 that functions to protect the zipper 111 and optional flexible loops 114 by which the feeding device 10 can be conveniently be grasped to be dragged or secured with straps, ropes or the like.

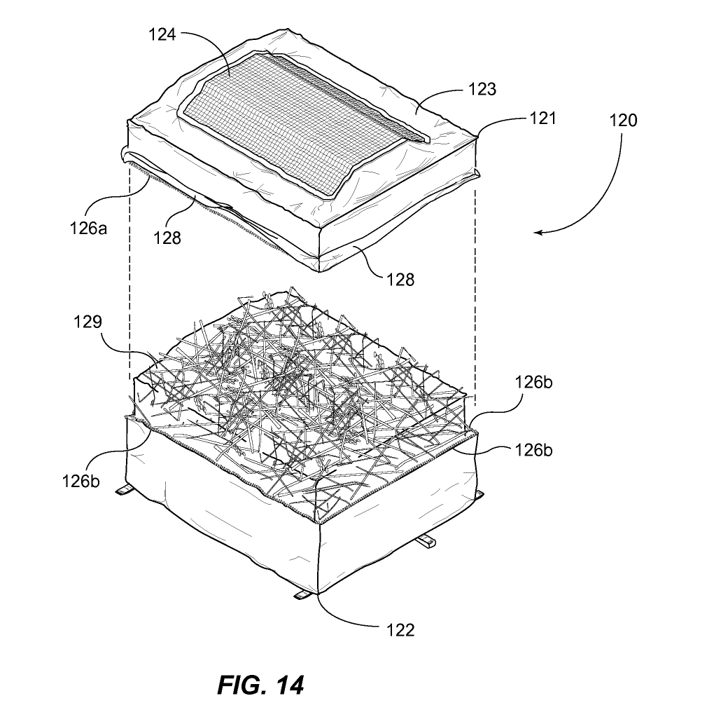

In FIG. 14 is depicted a horse-feeding device 120, wherein a flexible feeder receptacle has the form of a rectangular cuboid comprising an upper feeder receptacle portion 121 and a lower feeder receptacle portion 122 that can be totally joined or completely separated by means of a zipper mechanism comprising upper zipper portion 126a and a mating lower zipper portion 126b. In such an embodiment the upper zipper portion 126a is disposed to complete encircle the periphery of the lower edge of the upper feeder receptacle portion 121 while a mating lower zipper portion 126b is disposed to complete encircle the periphery of the lower edge of the upper feeder receptacle portion 122. Such a zipper configuration allows the upper feeder receptacle portion 121 and lower feeder receptacle portion 122 to be completely separated so that a bale of hay 129 can be conveniently introduced into the feeder 120.

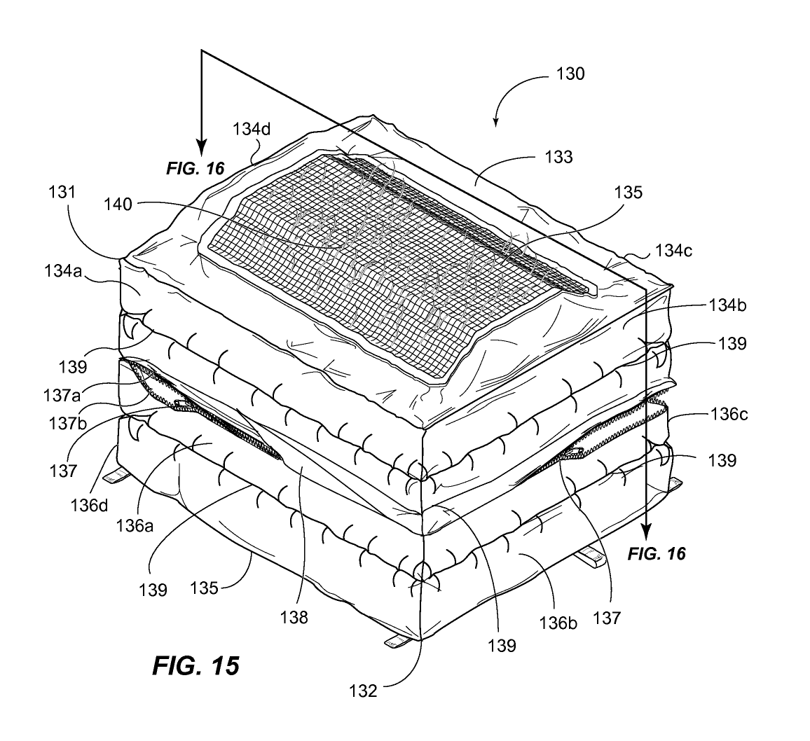

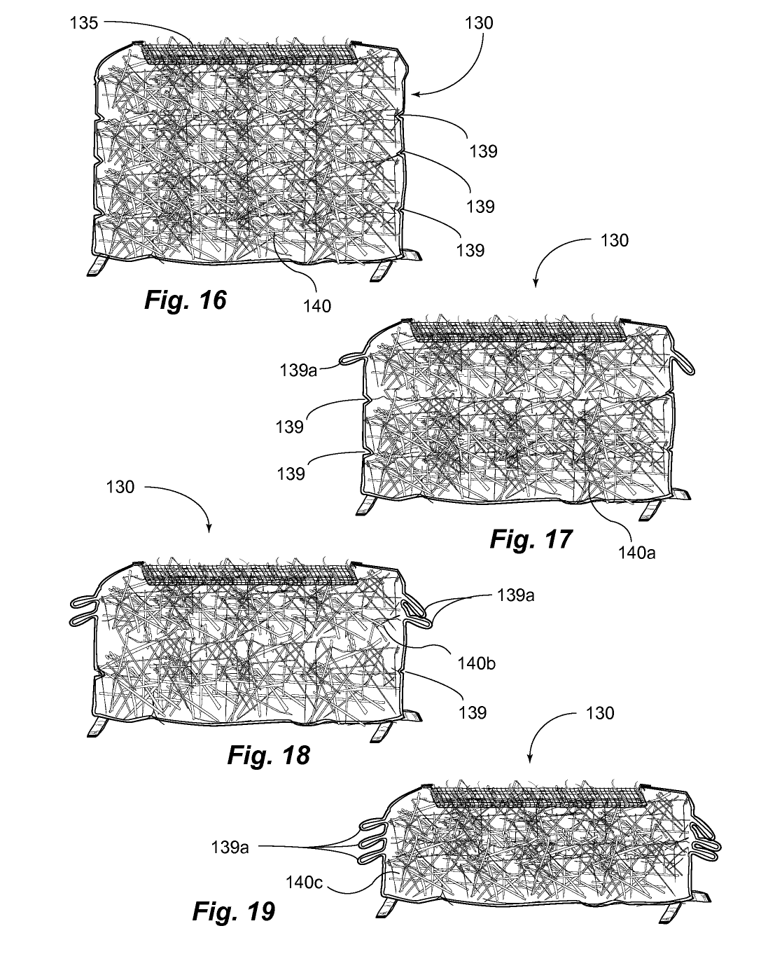

In certain embodiments of the animal feeders of the present invention that are configure to rest on the ground, the feeder receptacle is provided with one or more pleats disposed about the periphery so that the receptacle collapses under its own weight as a bale of hay contained therein is consumed by a feeding horse, such collapsing of the feeder receptacle, the moves the hay toward the feeding mesh to be accessible to the feeding animal. Such an embodiment is exemplified by the animal feeding device 130 illustrated in FIGS. 15-19, wherein a flexible feeder receptacle has the form of a rectangular cuboid comprising an upper feeder receptacle portion 131 and a lower feeder receptacle portion 132. The upper feeder receptacle portion 131 has a top wall 133 and four upper sidewalls 134a, 134b, 134c and 134d. A portion of the top wall 133 comprises a flexible open mesh 135, wherein the size of the mesh openings is chosen to permit only limited amounts of animal feed disposed within the receptacle to be accessed through the open mesh by a feeding animal such that the feeding animal consumes the contents of the receptacle over a period of time is feeder 130 collapses is dependant upon the size of the mesh openings. The lower feeder receptacle portion 132 has a bottom wall 135, and four lower sidewalls 136a, 136b, 136c and 136d. The upper sidewalls 134a, 134b, 134c and 134d are joined to the lower sidewalls 136a, 136b, 136c and 136d respectively by a reversible fastener in the form of a zipper 137 comprising an upper zipper portion 137a is disposed to complete encircle the periphery of the lower edge of the upper feeder receptacle portion 131 while a mating lower zipper portion 137b is disposed to complete encircle the periphery of the lower edge of the upper feeder receptacle portion 132. Such a zipper configuration allows the upper feeder receptacle portion 131 and upper feeder receptacle portion 132 to be completely separated so that a bale of hay can be conveniently introduced into the feeder 130. The upper feeder receptacle portion 132 further comprises an optional protective zipper flap 138. The upper sidewalls 134a, 134b, 134c and 134d and the lower sidewalls 136a, 136b, 136c and 136d comprise a series of pleats 139 the allow the entire feeding device 130 to receptacle collapses under its own weight in an accordion like manner as a bale of hay contained therein is consumed by a feeding horse. FIG. 16 depict a sectional view of the feeding device 130 illustrated in FIG. 15 having a bale of hay 140 disposed therein. FIGS. 17-19 depict sectional views of the feeding device 130 as the hay disposed therein is reduced in volume as an animal feeds wherein the feeder collapses in an accordion like manner by virtue of the pleats 139. FIG. 17 depicts a reduced quantity of hay 140a wherein a first pleat 139a is folded as the feeder 130 collapses. FIG. 18 depicts a further reduced quantity of hay 140b and wherein first and second pleats 139a are folded as the feeder 130 further collapses. FIG. 19 depicts a still further reduced quantity of hay 140c wherein first, second and third pleats 139a are folded as the feeder 130 still further collapses. The FIGS. 16-19 clearly illustrate that limited amounts of the hay 140 or other such animal fee disposed within the feeding device 130 can be continually accessed through the open mesh 135 by a feeding animal as the feeder 130 collapses and wherein the total quantity of feed that the feeding animal consumes over a period of time is dependant upon the size of the mesh openings.

Hay based horse feed is readily available in small bales that can be carried by hand for use in 1-2 horse feeding situations. Although such bales are rectangular, manufacturers commonly use the term “square” bales to differentiate them from round bales. A typical small square (rectangular) hay bale has a volume of about 10 ft³ to about 16 ft³ and is secured with wire or twine. Although the bale weight depends on the specific type of hay and the settings used with the baling equipment, a typical small square (rectangular) bale commonly weights about 125 lbs. However, for purposes of the present invention the actual dimensions and/or volume of the hay bale are not limiting.

Embodiments of the components of the feeders of the present invention can be constructed of any abrasion resistant and cut resistant flexible material. In certain embodiments the abrasion resistant material is leather. In certain other embodiments the abrasion resistant material is a sheet or film comprising a synthetic polymer including but not limited to vinyls, nylons, polyesters, polyamides, polyolefins, aramids as well as combinations and mixtures thereof. In certain other embodiments the abrasion resistant material is chosen from among the numerous commercially available forms of reinforced plastic sheeting including, but not limited to, nylon string reinforced polyethylene sheeting, woven polyethylene sheeting and the like.

In certain preferred embodiments the flexible bag-like receptacles are constructed of heavy duty textiles including, but not limited to, heavy duty hemp fabric, cotton canvas, nylons, polyesters, polyamides, polyolefins, aramids and the like. A particularly useful abrasion resistant flexible textile material is 1000 Denier Cordura™ nylon.

The mesh materials of preferred embodiments are also referred to as netting materials and can be fabricated from multi-strand and monofilament wires, yarns and fibers. Preferred embodiments comprise metals, synthetic yarns and fibers comprising materials including, but not limited to, nylons, polyesters, polyamides, polyolefins, aramids and the like. While there is no limitation to the configuration of such a mesh material, square, diamond and round configurations are preferred.

While the size of the feeding mesh openings is dependent on the type and quantity of feed used, in certain embodiments the average size of the mesh openings in the open mesh material through which the feeding animal obtains the feed is from 0.05 in² to 4.0 in² with an opening of 0.10 in² to 2.5 in² in certain preferred embodiments and an opening of 0.25 in² to 1.75 in² in certain most preferred embodiments. While there is no limit to the size and feed capacity of the present invention, in certain embodiments the flexible bag-like receptacle is dimensioned to accommodate from 10 to 30 lbs or more of an animal feed such as hay.

The bottom mesh materials useful in embodiments of the present invention have a mesh size that allows fine debris such as dirt and dust to pass through while retaining the feed within the receptacle. The average size of the mesh openings in such a bottom mesh is from 0.001 in² to 0.40 in² in typical embodiments, while an average size of the mesh openings is 0.01 in² to 0.25 in² in certain preferred embodiments and average size of the mesh openings is 0.05 in² to 0.10 in² in certain most preferred embodiments.

Suitable reversible closures for embodiments of the present invention include, but are not limited to zippers, grommet/cord or grommet/rope combinations, buckles, snaps, elastic bands and the like.

The embodiments described and illustrated herein are exemplary and it will be understood by a person of skill in the art that there is no limitation on the disposition and/or dimensions of the various elements depicted or of the various possible combinations of these elements.

We claim:

1. A horse feeder comprising:
a flexible receptacle that comprises a top wall, a bottom wall, and a feed entry opening;
wherein at least a portion of the top wall comprises a flexible feeding mesh with feeding mesh openings of a size chosen to permit only limited amounts of animal feed disposed within the receptacle to be accessed through the open mesh by a feeding animal, such that the feeding animal consumes the contents of the receptacle over a period of time dependant upon the size of the feeding mesh openings chosen; and
wherein the flexible receptacle is configured such that when bottom wall rests upon a ground surface, the top wall is facing in a upward direction such that a feeding animal in a standing position can only access feed disposed within the receptacle when the feeding animal's head is lowered in a natural feeding headset.

2. The feeder of claim 1 wherein the flexible receptacle further comprises four sidewalls and has the form of a rectangular cuboid.

3. The feeder of claim 2 wherein the a feed entry opening is disposed circumferentially about at least three of the four sidewalls of the receptacle and is configured such that a bale of animal feed can be introduced there through.

4. The feeder of claim 3 wherein the four sidewalls each comprise one or more pleats parallel to the bottom wall and wherein each pleat is disposed to be contiguous with the pleats of adjacent sidewalls such that the four sidewalls are fully extended when the feeder is filled with animal feed and collapse in an accordion-like manner as feed within the feeder is consumed by a feeding animal.

5. The feeder of claim 1 wherein the flexible receptacle comprises an abrasion resistant material and wherein the flexible feeding mesh is fabricated from a feeding mesh material resistant to cutting by the teeth of a feeding animal.

6. The feeder of claim 5 wherein the abrasion resistant material is a textile.

7. The feeder of claim 5 wherein the abrasion resistant material is leather.

8. The feeder of claim 5 wherein the abrasion resistant material comprises a material selected from the group consisting of polyolefins, nylons, polyesters, polyamides, and polyaramids combinations thereof.

9. The feeder of claim 5 wherein the feeding mesh material comprises a material selected from the group consisting of polyolefins, nylons, polyesters, polyamides, polyaramids and combinations thereof.

10. The feeder of claim 1 wherein the feed entry opening is provided with a reversible sealing means.

11. The feeder of claim 11 wherein the reversible sealing means is a zipper.

12. The feeder of claim 11 wherein the reversible sealing means comprises a plurality of grommets disposed around the periphery of the feed entry opening and a cord threaded through the grommets such that the feed entry opening is sealed when the chord is pulled taught.

13. The feeder of claim 1 wherein the average size of the feeding mesh openings is from 0.25 in² to 1.75 in².

14. A horse feeder comprising:
a flexible bag-like receptacle, having a front wall, a back wall, a closed bottom and an open top;
wherein the open top is configured to function as a feed entry opening through which a desired quantity of animal feed can be introduced; and wherein at least a portion of front wall comprises a flexible feeding mesh wherein the size of the feeding mesh is chosen to permit only limited amounts of animal feed disposed within the receptacle to be accessed through the mesh by a feeding animal such that the feeding animal consumes the contents of the receptacle over predetermined period of time; and
a hanging means disposed such that the receptacle can be hung in a stall or other such animal housing so that the flexible open mesh is positioned wherein a feeding animal in a standing position can access feed disposed within the receptacle only when the feeding animal's head is lowered in a natural feeding headset.

15. The feeder of claim 14 wherein the hanging means is a cord, belt or strap.

16. The feeder of claim 14 wherein the feed entry opening is provided with a reversible sealing means.

17. The feeder of claim 16 wherein the reversible sealing means comprises a plurality of grommets disposed around the periphery of the feed entry opening and a cord threaded through the grommets such that the feed entry opening is sealed when the chord is pulled taught.

18. The feeder of claim 17 wherein the chord also functions as a hanging means.

19. The feeder of claim 14 wherein the flexible receptacle comprises an abrasion resistant material and wherein the flexible feeding mesh comprises a feeding mesh material resistant to cutting by the teeth of a feeding animal.

20. The feeder of claim 19 wherein the abrasion resistant material is a textile.

21. The feeder of claim 19 wherein the abrasion resistant material is leather.

22. The feeder of claim 19 wherein the abrasion resistant material comprises a material selected from the group consisting of polyolefins, nylons, polyesters, polyamides, and polyaramids combinations thereof.

23. The feeder of claim 19 wherein the feeding mesh material comprises a material selected from the group consisting of polyolefins, nylons, polyesters, polyamides, polyaramids and combinations thereof.

24. The feeder of claim 14 wherein the average size of the feeding mesh openings is from about 0.10 in² to 2.50 in².

25. The feeder of claim 14 wherein the closed bottom comprises a bottom mesh that is sized to allow fine debris to pass through while retaining feed disposed within the receptacle.

26. The feeder of claim 24 wherein the average size of the bottom mesh openings is from about 0.01 in² to 0.25 in².
